(19) United States
(12) Patent Application Publication
(10) Pub. No.: US 2013/0088445 A1
(43) Pub. Date: Apr. 11, 2013

(54) APPARATUS AND METHOD FOR CONTROLLING TOUCHSCREEN OF A PORTABLE TERMINAL

(71) Applicant: Yeon-Ho Kang, Suwon-si (KR)

(72) Inventor: Yeon-Ho Kang, Suwon-si (KR)

(73) Assignee: SAMSUNG ELECTRONICS CO., LTD., Suwon-si (KR)

(21) Appl. No.: 13/619,296

(22) Filed: Sep. 14, 2012

(30) Foreign Application Priority Data
Oct. 6, 2011 (KR) 10-2011-0101941

(51) Int. Cl. G06F 3/041

(52) U.S. Cl. 345/173

(57) ABSTRACT

According to one embodiment, a method for controlling a touchscreen of a portable terminal includes detecting a start signal and deactivating an edge region of the touchscreen in response to the start signal.

### CROSS-REFERENCE TO RELATED APPLICATION AND CLAIM OF PRIORITY

The present application is related to and claims priority under 35 U.S.C. §119(a) to a Korean Patent Application filed in the Korean Intellectual Property Office on Oct. 6, 2011 and assigned Ser. No. 10-2011-0101941, the contents of which are herein incorporated by reference.

### TECHNICAL FIELD OF THE INVENTION

The present invention relates generally to display devices, and more particularly, to an apparatus and method for controlling a touchscreen of a portable terminal.

### BACKGROUND OF THE INVENTION

As utilization of touchscreen portable terminals increases, users tend to prefer larger touchscreens. The increased size of touchscreens inevitably leads to an increase in size of terminals. Thus, in order to achieve the foregoing purpose, in general, an edge frame (or a bezel) is formed to be thin. The bezel refers to a portion for fabricating a circuit to be connected with a driving IC in a touchscreen panel (TSP). FIG. 1 illustrates a general touchscreen portable terminal 10 that includes a touchscreen panel 12 and a case frame forming an external appearance of a portable terminal 10. The case frame includes an bezel that comprises the edge frame of the case frame.

The bezel 1 protects and reinforces the touchscreen panel 12 and may generally include a display panel, a polarizing film, protective glass, a touch panel, and the like. In addition, the bezel 1 serves to prevent erroneous touch events. For example, when a user touches the portable terminal 10 held with his or her hand, the bezel 1 prevents an edge portion from being erroneously touched by the user's hand while holding the portable terminal 10. However, as the thickness of the bezel 1 is increasingly reduced, the user's hand holding the portable terminal 10 becomes closer to the edge region, causing a limitation in preventing an erroneous touch by using such a bezel 1.

### SUMMARY OF THE INVENTION

To address the above-discussed deficiencies of the prior art, it is a primary object to provide at least the advantages below. Accordingly, an object of the present disclosure is to provide a portable terminal that reduces a thickness of an edge frame (bezel) of a touchscreen panel in a manner such that an enlarged bezel may not be necessary.

Another object of the present disclosure is to provide an apparatus and method for controlling a touchscreen, which can prevent an erroneous touch of a user that may be readily caused as a bezel of a touchscreen panel that is relatively thin in size.

Still another object of the present disclosure is to provide an apparatus and method for controlling a touchscreen, which can prevent an occurrence of an erroneous touch event by deactivating an edge region of a touchscreen, that is, a touch region of a certain size adjacent to a bezel.

Yet another object of the present disclosure is to provide an apparatus and method for controlling a touchscreen, which can visually magnify/reduce a screen by activating/deactivating an edge region of a touchscreen to be an active/inactive touch region.

In accordance with an object of the present disclosure, a method for controlling a touchscreen of a portable device is provided. The method includes detecting a start signal, and deactivating an edge region of the touchscreen in response to the start signal.

In accordance with another object of the present disclosure, an apparatus for controlling a touchscreen of a portable device is provided. The apparatus includes a touchscreen unit configured to output a signal corresponding to a touch event and display content corresponding to an image signal under the control of a control unit, and a control unit configured to deactivate an edge region of the touchscreen when a start signal is detected.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts: The above and other objects, features and advantages of the present disclosure will become more apparent from the following detailed description when taken in conjunction with the accompanying drawings in which:

FIG. 1 illustrates an example touchscreen of a portable terminal according to one embodiment of the present disclosure;

FIG. 2 illustrates another example touchscreen portable terminal according to an embodiment of the present disclosure;

FIG. 3 illustrates an example touchscreen portable terminal according to an embodiment of the present disclosure;

FIG. 4 illustrates an example procedure of applying a software bezel according to an embodiment of the present disclosure;

FIG. 5 illustrates an example screen for activating and deactivating the software bezel according to an embodiment of the present disclosure;

FIGS. 6A to 6C illustrate various example touch types for generating a start signal and an end signal with respect to the software bezel according to an embodiment of the present disclosure; and

FIGS. 7 and 8 illustrate example techniques for determining a position and a size of the software bezel according to an embodiment of the present disclosure by a user.

### DETAILED DESCRIPTION OF THE INVENTION

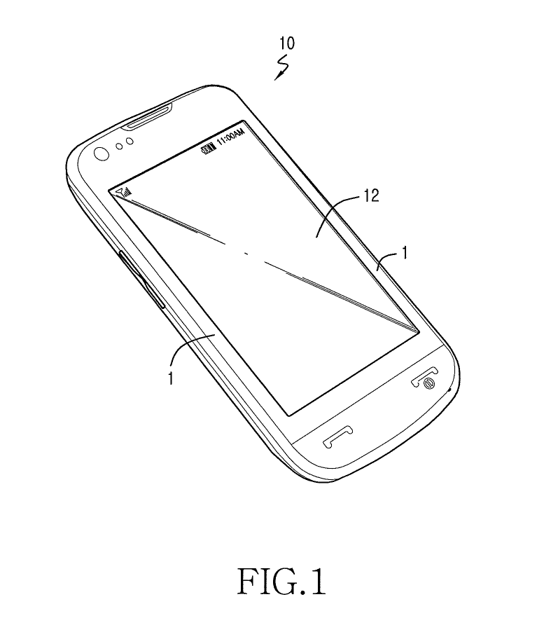

FIGS. 1 through 8, discussed below, and the various embodiments used to describe the principles of the present disclosure in this patent document are by way of illustration only and should not be construed in any way to limit the scope of the disclosure. Exemplary embodiments of the present disclosure will be described herein below with reference to the accompanying drawings. In the following description, detailed descriptions of well-known functions or configurations will be omitted since they would unnecessarily obscure the subject matters of the present disclosure. Also, the terms used herein are defined according to the functions of the present disclosure. Thus, the terms may vary depending on users' or operators' intentions or practices. Therefore, the terms used herein must be understood based on the descriptions made herein.

The present disclosure relates to a touchscreen portable terminal and, more particularly, to a portable terminal that can implement a larger touchscreen without having to increasing the volume of the terminal by minimizing the thickness of an edge frame (or a bezel) of a touchscreen panel and also to an apparatus and method for controlling a touchscreen, which can prevent an erroneous touch that may frequently occur as the bezel is reduced in thickness.

In an embodiment of the present disclosure, an edge touch region of a touchscreen, namely, an edge region of a certain size adjacent to a bezel, is deactivated according to circumstances, to achieve a certain purpose, and according to this operation, the screen is visually magnified and reduced. As described hereafter, the touchscreen portable terminal does not display a content in the deactivated region and disregards a touch occurring at the deactivated region, thereby disabling an intrinsic function of the touchscreen. In addition, the touchscreen portable terminal displays a content in a region other than the deactivated region, namely, an activated region, and performs a relevant operation according to a touch generated in the active region.

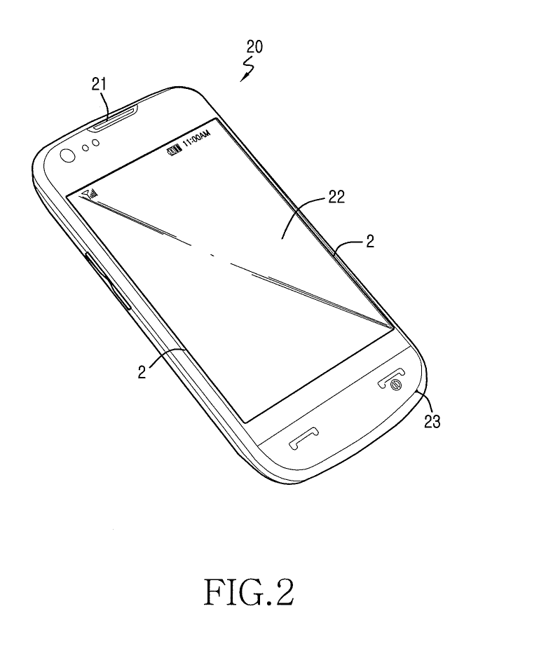

FIG. 2 illustrates a perspective view of a touchscreen portable terminal according to an embodiment of the present disclosure.

Referring to FIG. 2, a touchscreen portable terminal 20 includes a speaker 21 for outputting a sound, a touchscreen panel (TSP) 22 for outputting an image and generating an electrical signal corresponding to a touch by a user, and a microphone 23 for converting sounds into associated electrical signals.

The touchscreen portable terminal 20 includes an edge frame (hereinafter referred to as a ‘bezel’) 2 for mounting the touchscreen panel 22. The bezel 2 refers to a portion of the frame for housing a circuit connected to a driving IC in the TSP 22, which may represent the entirety or a portion of a case frame of the touchscreen portable terminal 20. Alternatively, the bezel 2 may represent a separate frame combined with the case frame. As illustrated, the bezel 2 of the touchscreen portable terminal 20 is configured such that a lateral portion thereof is thin, but the present disclosure is not limited thereto. However, in order to describe the gist of the present disclosure in detail, it is assumed that the touchscreen portable terminal according to an embodiment of the present disclosure includes the bezel 2 having a relatively low profile.

When the user grasps the touchscreen portable terminal 20, an unintended erroneous touch may be generated from a touch region adjacent to the bezel 2. Thus, in the touchscreen portable terminal 20, a touch region (hereinafter referred to as an ‘edge region’) that includes a certain specified region adjacent to the bezel 2 is deactivated according to circumstances to further implement a software bezel. The touchscreen portable terminal 20 may disregard a detected touch event generated in the software bezel. As a result, the software bezel can prevent an occurrence of an erroneous touch event in the edge region, which may be problematic due to the relatively thin hardware bezel 2. In addition, the touchscreen portable terminal 20 adjusts a content, which was displayed in the edge region that excludes the software bezel according to the ratio to display the content. Also, the touchscreen portable terminal 20 may generate the software bezel to have the same color as that of the bezel 2 to allow the user to view (or feel) the screen as if the bezel is magnified and the screen is reduced.

The touchscreen portable terminal 20 does not display contents on the software bezel and disregards a touch generated in the software bezel, thus disabling an intrinsic function of the touchscreen. In addition, the touchscreen portable terminal 20 displays a content in the region other than the bezel, namely, in the activated region, and performs a relevant operation according to a touch event generated in the active region.

The touchscreen panel 22 may be a known pressure-sensitive touchscreen panel or electrostatic touchscreen panel. In particular, when a self-luminous display panel such as a plasma display panel (PDP), an organic light emitting diode (OLED), or the like, is used as the display panel 20, the touchscreen portable terminal 20 may be configured to turn off only the software bezel portion.

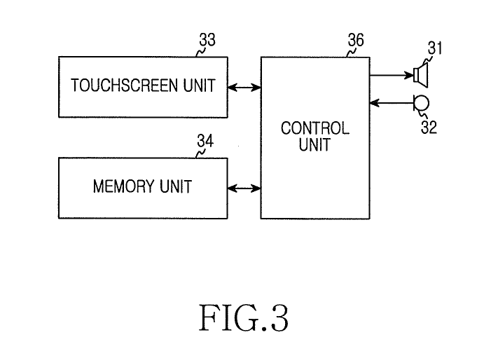

FIG. 3 illustrates an example touchscreen portable terminal according to an embodiment of the present disclosure.

Referring to FIG. 3, the touchscreen portable terminal includes a speaker 31, a microphone 32, a touchscreen unit 33, a memory unit 34, and a control unit 36.

The touchscreen unit 32 outputs a signal corresponding to a touch event and displays a content corresponding to an image signal under the control of the control unit 36. The memory unit 34 stores data regarding an operation of the terminal, and the control unit 36 loads information from the memory unit 34 to perform operations according to an embodiment of the present disclosure.

The control unit 36 sets an execution environment of the terminal, retains relevant information, enables the terminal to be stably driven, and controls the various elements of the terminal to smoothly exchange data output. The control unit 36 may include a codec that converts signals associated with an image and a voice through the touchscreen unit 33, the speaker 31, and the microphone 32.

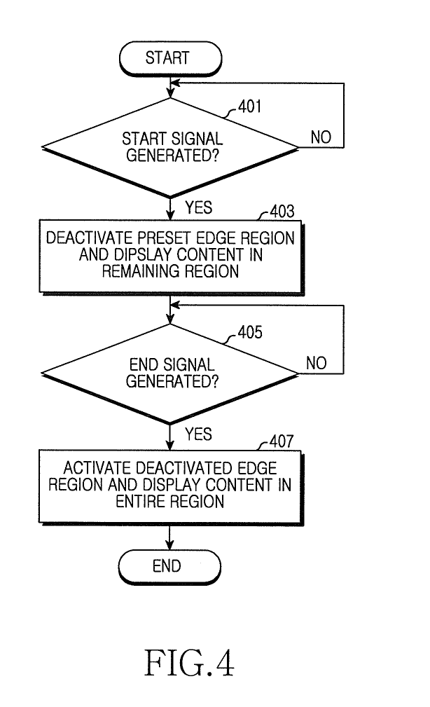

FIG. 4 illustrates an example procedure of applying the software bezel according to an embodiment of the present disclosure.

Referring to FIG. 4, when a start signal is generated in step 401, the control unit 36 deactivates a pre-set edge region and displays content in the other remaining region in step 403. In some cases, the edge region may be displayed such that the user may feel as if the bezel is magnified and the screen displaying content is reduced.

Thereafter, when an end signal is generated, the control unit 36 activates the deactivated edge region and displays the content on the entire region of the touchscreen.

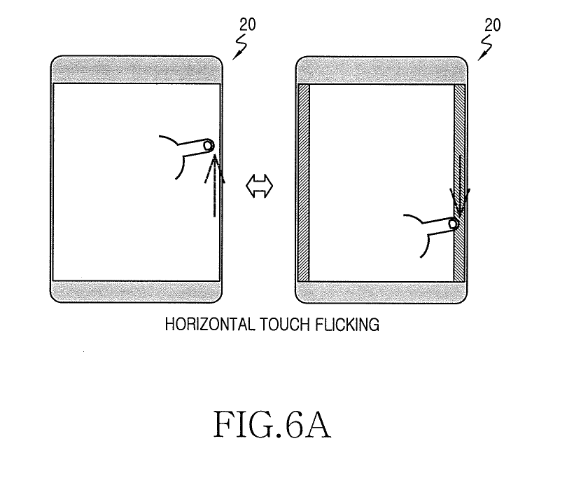

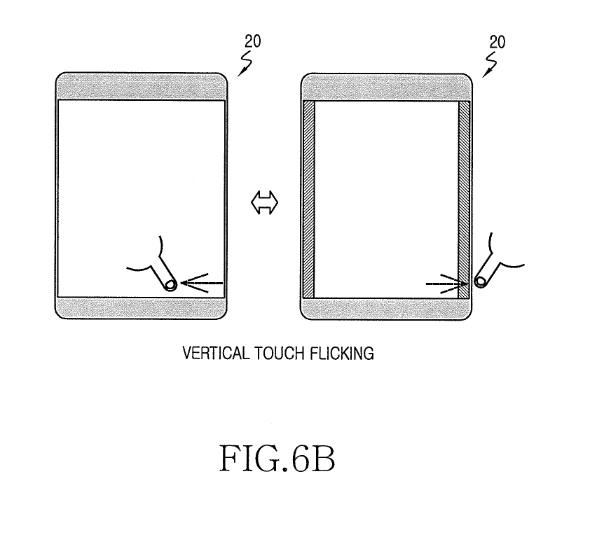

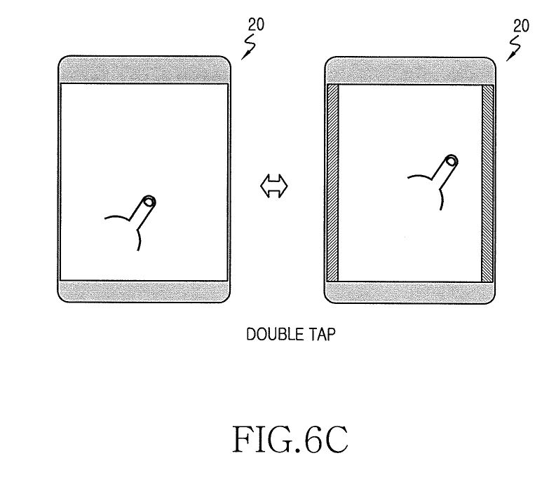

FIGS. 6A to 6C illustrate various example touch types for generating a start signal and an end signal with respect to the software bezel according to an embodiment of the present disclosure. As illustrated in FIGS. 6A and 6B, a touch type of the start signal and the end signal may include a horizontal or vertical touch action performed by the user, such as, for example by flicking the touchscreen. In addition, as illustrated in FIG. 6C, a touch type of the start signal and the end signal may include a double tap of the touchscreen.

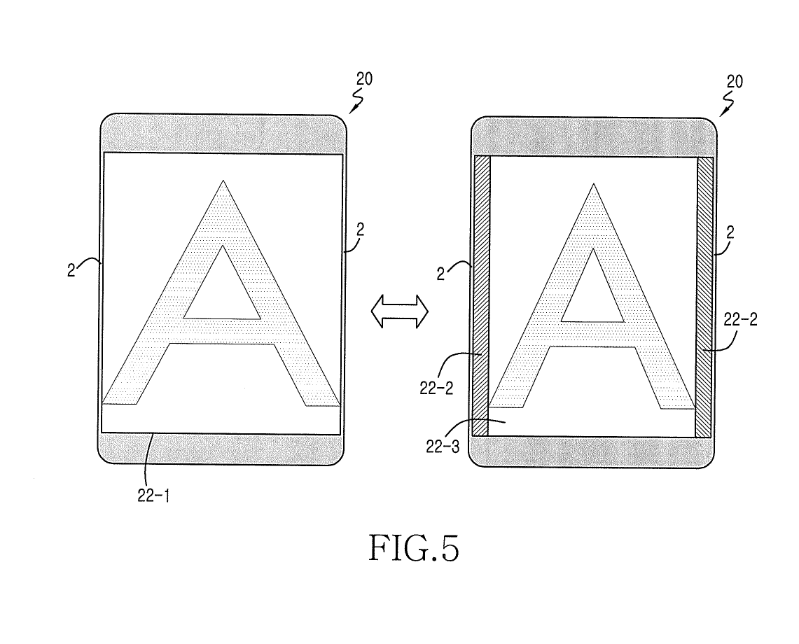

FIG. 5 illustrates a an example screen for activating and deactivating the software bezel according to an embodiment of the present disclosure.

Referring to FIG. 5, in a state where content (e.g., a video, a photo, a web page, or the like) is displayed on the entire region 22-1 of the touchscreen, when the start signal is generated, a specified edge region 22-2 is deactivated and the content is appropriately displayed on the remaining region 22-3. Thereafter, when the end signal is generated, the deactivated edge region 22-2 is activated and the content is displayed on the entire region 22-1 again. Here, although the user touches the deactivate edge region 22-2, the terminal disregards it. In particular, in the case of a touchscreen including a self-luminous display panel, the edge region 22-2 may be turned off to be deactivated.

The deactivated edge region 22-2 may complement the relatively thin hardware bezel 2, preventing an erroneous operation resulting from an unintentional touch. The deactivated edge region 22-2 may be displayed to have the same color as that of the bezel 2 such that the user may feel as if the bezel is magnified and the screen is reduced.

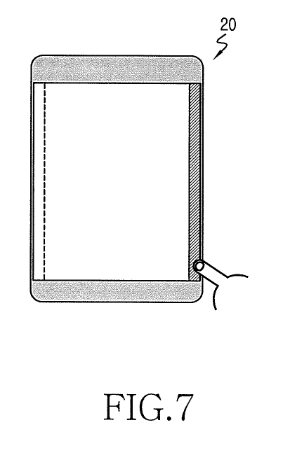

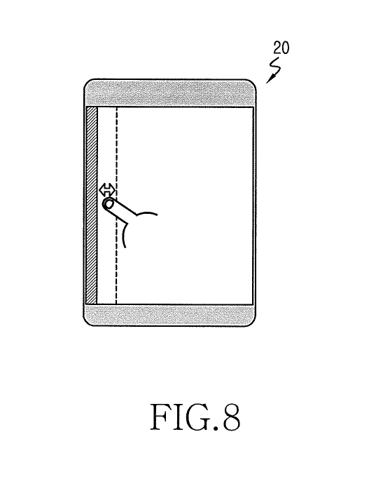

In addition, the touchscreen portable terminal 20 may generate the edge region 22-2 to allow the user to determine the edge region 22-2. FIGS. 7 and 8 illustrate example screens for determining a position and a size of the software bezel according to an embodiment of the present disclosure. For example, the user may determine at least one or more of an upper, a lower, a right, and a left side of the touchscreen as a position of the software bezel and determine a size of the software bezel. Such a function may provided to accommodate of user's personality. For example, a right-handed user may determine a position and a size for reducing an occurrence of an erroneous touch event differently from those of a left-handed user. Thus, the control unit 36 may perform a process of confirming the position and the size of the software bezel previously determined in step 403 in FIG. 4.

In addition, the position and the size of the software bezel may be set for each application. In addition, whether to allow the software bezel to be activated may be set for each application. For example, a keyboard application may be set to essentially include the software bezel.

In conclusion, the portable terminal according to an embodiment of the present disclosure can include a larger screen by minimizing the thickness of the edge frame (bezel) of the touchscreen panel without having to increase the overall size of the device, and prevent an erroneous touch event that may readily occur as the thickness of the edges is reduced.

It will be appreciated that embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program.

While the disclosure has been shown and described with reference to certain exemplary embodiments thereof, it will be understood by those skilled in the art that various changes in form and details may be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. A method for controlling a touchscreen of a portable terminal, the method comprising:
detecting a start signal; and
deactivating an edge region of the touchscreen in response to the start signal.

2. The method of claim 1, further comprising:
displaying content in a remaining region that excludes the edge region of the touchscreen.

3. The method of claim 2, further comprising:
when an end signal is generated, activating the deactivated edge region and displaying the content in the entire region of the touchscreen.

4. The method of claim 1, wherein, in deactivating the edge region of the touchscreen, a position of the edge region is confirmed.

5. The method of claim 4, wherein the position of the edge region of the touchscreen includes one or more of an upper, a lower, a right, and a left side of the touchscreen.

6. The method of claim 4, wherein the position of the edge region of the touchscreen is set for each application.

7. The method of claim 1, wherein, in deactivating the edge region of the touchscreen, a size of the edge region is confirmed.

8. The method of claim 7, wherein a size of the edge region of the touchscreen is set for each application.

9. The method of claim 1, wherein, in deactivating the edge region of the touchscreen, a touch signal generated in the edge region is disregarded.

10. The method of claim 1, wherein, in deactivating the edge region of the touchscreen, a relevant color is displayed in the edge region.

11. The method of claim 1, wherein the start signal comprises a relevant touch event.

12. An apparatus configured to control a touchscreen of a portable terminal, the apparatus comprising:
a touchscreen unit configured to output a signal corresponding to a touch of the touchscreen and display content corresponding to an image signal under the control of a control unit; and
a control unit configured to deactivate an edge region of the touchscreen when a start signal is detected.

13. The apparatus of claim 12, wherein the control unit is configured to display the content in a remaining region that excludes the edge region of the touchscreen.

14. The apparatus of claim 13, wherein when an end signal is generated, the control unit is configured to activate the deactivated edge region of the touchscreen and display the content in the entire region of the touchscreen.

15. The apparatus of claim 12, wherein the control unit is configured to confirm the position of the edge region of the touchscreen.

16. The apparatus of claim 15, wherein the position of the edge region of the touchscreen comprises one or more of an upper, a lower, a right, and a left side of the touchscreen.

17. The apparatus of claim 15, wherein the controller is configured to set the position of the edge region of the touchscreen for each application.

18. The apparatus of claim 12, wherein the control unit is configured to confirm a size of the edge region of the touchscreen.

19. The apparatus of claim 18, wherein the controller is configured to set a size of the edge region of the touchscreen for each application.

20. The apparatus of claim 12, wherein the control unit is configured to disregard a touch signal generated in the deactivated edge region of the touchscreen.

21. The apparatus of claim 12, wherein the control unit is configured to display a relevant color in the deactivated edge region of the touchscreen.

22. The apparatus of claim 12, wherein the start signal comprises a relevant touch event.
